(19) United States
(12) Patent Application Publication
(10) Pub. No.: US 2026/0323434 A1
(43) Pub. Date: Oct. 15, 2026

(54) BLUETOOTH LOW ENERGY SNIFFING AND HANDOVER

(71) Applicant: Cypress Semiconductor Corporation, San Jose, CA (US)

(72) Inventors: Victor ZHODZISHSKY, Potomac, MD (US); Narasimha Rao KONAIAH, San Diego, CA (US); Cyrill KRYMMER, San Diego, CA (US)

(73) Assignee: Cypress Semiconductor Corporation, San Jose, CA (US)

(21) Appl. No.: 19/344,371

(22) Filed: Sep. 29, 2025

Related U.S. Application Data
(60) Provisional application No. 63/787,472, filed on Apr. 11, 2025.

(51) Int. Cl. H04W 36/00; G01S 5/02; G01S 5/14

(52) U.S. Cl. CPC H04W 36/035; G01S 5/02213; G01S 5/14; H04W 36/0055

(57) ABSTRACT

A BLE anchor includes a BLE controller and a transceiver communicatively coupled to the BLE controller. The BLE controller is configured to be communicatively coupled to a plurality of BLE anchors and a host controller. The BLE controller is configured to establish, via the transceiver, an active BLE connection to a user device in response to the user device being within range and not having an active BLE connection to a BLE anchor of the plurality of BLE anchors. The BLE controller is configured to establish, via the transceiver, a sniffing connection to the user device in response to the user device being within range and having an active BLE connection to a BLE anchor of the plurality of BLE anchors. The BLE controller is configured to report to the host controller a received signal strength indicator (RSSI) for user device packets received by the transceiver.

### CROSS-REFERENCE TO RELATED APPLICATION

This application claims the benefit of U.S. Provisional Application No. 63/787,472, filed on Apr. 11, 2025, which is incorporated by reference herein.

### TECHNICAL FIELD

The present disclosure relates generally to Bluetooth low energy (BLE). More particularly, it relates to devices, systems, and methods for BLE sniffing and active connections, handover, and ranging.

### BACKGROUND

There are scenarios where the range and/or location of multiple users/devices (e.g., smart phones, smart watches, key fobs, etc.) relative to an object, such as a vehicle, is desired to enable access. Simultaneous range estimation for multiple devices approaching the vehicle is preferred to provide the best user experience. Accordingly, a vehicle access system behavior should not change when two or more devices are approaching the vehicle from different directions. Bluetooth low energy (BLE) may be used to establish a connection between the vehicle and a user device and to authenticate the user device. If the connection between the user device and the vehicle drops while the user is moving towards a particular door, which may include the user moving around the vehicle, reconnection and reauthentication may be required between the user device and the vehicle. If there is insufficient time to reauthenticate the user device (e.g., before the user reaches the door), the user experience may be affected.

For these and other reasons, a need exists for the claimed subject matter.

### BRIEF DESCRIPTION OF THE DRAWINGS

FIGS. 1A and 1B are block diagrams illustrating example systems including Bluetooth low energy (BLE) anchors.

FIGS. 2A and 2B are schematic diagrams illustrating example vehicles including BLE anchors.

FIG. 3 is a block diagram illustrating an example BLE anchor.

FIGS. 4A-4E are flow diagrams illustrating example methods for operating a BLE anchor.

FIG. 5 is a timing diagram illustrating an example method for establishing a sniffing connection at a BLE anchor.

FIGS. 6A and 6B are timing diagrams illustrating example methods for handing over an active BLE connection from one BLE anchor to another BLE anchor.

FIGS. 7A-7F are flow diagrams illustrating example methods for operating systems including BLE anchors.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

There are scenarios where the range and/or location of multiple users/devices (e.g., smart phones, smart watches, key fobs, etc.) needs to be estimated by a group of Bluetooth devices, such as Bluetooth low energy (BLE) vehicle access anchors. Multiple BLE anchors may be used to improve the accuracy of the range estimation. While BLE ranging may be used for location estimation, in some examples, BLE ranging may also be used to determine when to start secure ultra-wide band (UWB) ranging. By using BLE ranging to determine when to start secure UWB ranging, power consumption may be reduced since UWB ranging consumes significantly more power than BLE ranging. Without first using BLE ranging and by using only UWB ranging, the power consumption would be significantly higher by both the user device and the vehicle.

Accordingly, disclosed herein are devices, systems, and methods for detecting the proximity of user devices (e.g., smart phones, smart watches, key fobs, etc.) to a vehicle by using multiple BLE anchors through sniffing connections and the handover of active BLE connections. The devices, systems, and methods improve the user experience by handing over active BLE connections seamlessly between BLE anchors when a user moves around the vehicle. The devices, systems, and methods may use BLE ranging to turn on UWB ranging at an appropriate time to reduce power consumption. In some examples, the BLE ranging may be used to turn on UWB ranging on specific UWB anchors. The devices, systems, and methods may also detect and fix errors during BLE ranging.

Some examples of the present disclosure relate to a Bluetooth low energy (BLE) anchor. The BLE anchor includes a BLE controller and a transceiver. The BLE controller is configured to be communicatively coupled to a plurality of BLE anchors and a host controller. The transceiver is communicatively coupled to the BLE controller. The BLE controller is configured to establish, via the transceiver, an active BLE connection to a user device in response to the user device being within range and not having an active BLE connection to a BLE anchor of the plurality of BLE anchors. The BLE controller is configured to establish, via the transceiver, a sniffing connection to the user device in response to the user device being within range and having an active BLE connection to a BLE anchor of the plurality of BLE anchors. The BLE controller is configured to report to the host controller a received signal strength indicator (RSSI) for user device packets received by the transceiver.

Other examples of the present disclosure relate to a system. The system includes a host controller and a plurality of Bluetooth low energy (BLE) anchors communicatively coupled to the host controller. In response to detecting a user device, a first BLE anchor of the plurality of BLE anchors establishes an active BLE connection with the user device and broadcasts active BLE connection data to the remaining plurality of BLE anchors. In response to receiving the active BLE connection data, each of the remaining plurality of BLE anchors establish a sniffing connection to the user device. Each of the plurality of BLE anchors reports a received signal strength indicator (RSSI) for received user device packets to the host controller. The host controller estimates a location of the user device based on the RSSI received from each of the plurality of BLE anchors.

Yet other examples of the present disclosure relate to a method. The method includes detecting, via a plurality of Bluetooth low energy (BLE) anchors, a user device approaching the plurality of BLE anchors. The method includes establishing, via a first BLE anchor of the plurality of BLE anchors, an active BLE connection to the user device. The method includes broadcasting, via the first BLE anchor, active BLE connection information to the remaining plurality of BLE anchors. The method includes establishing, via the remaining plurality of BLE anchors, a sniffing connection to the user device based on the active BLE connection information.

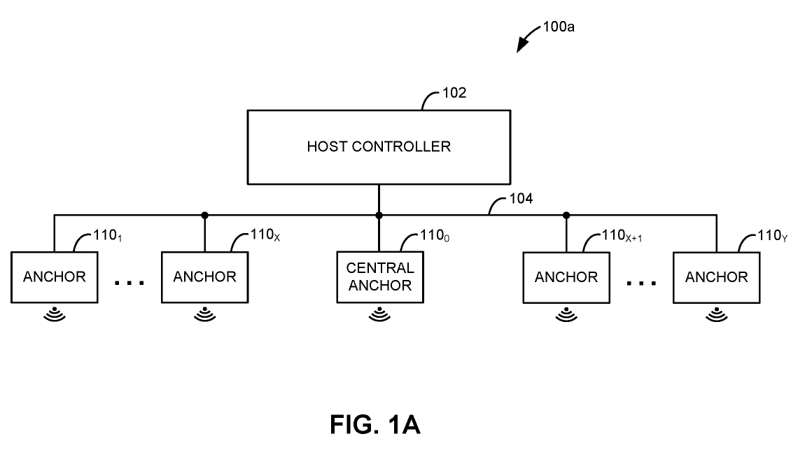

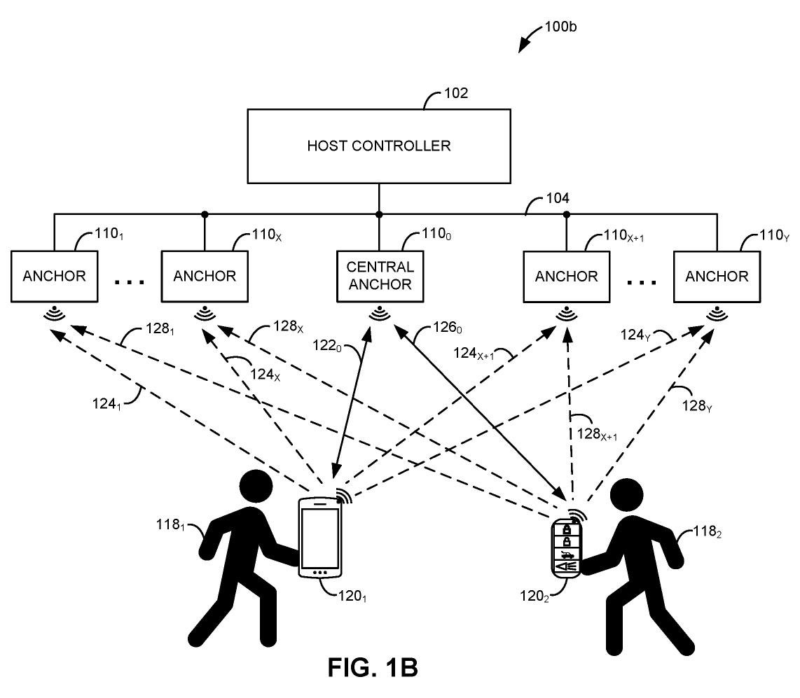

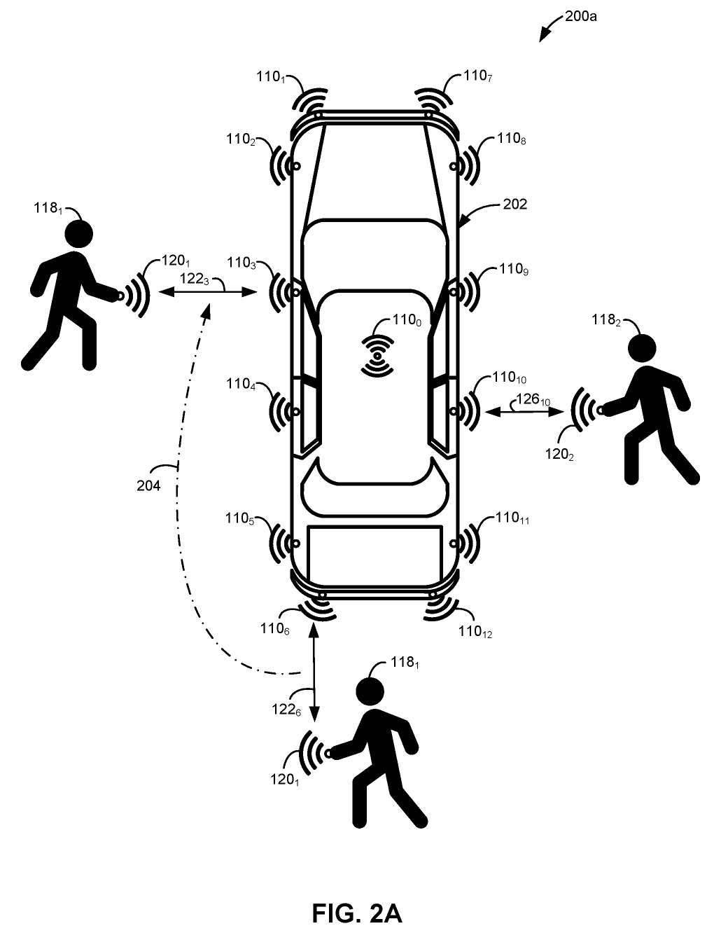

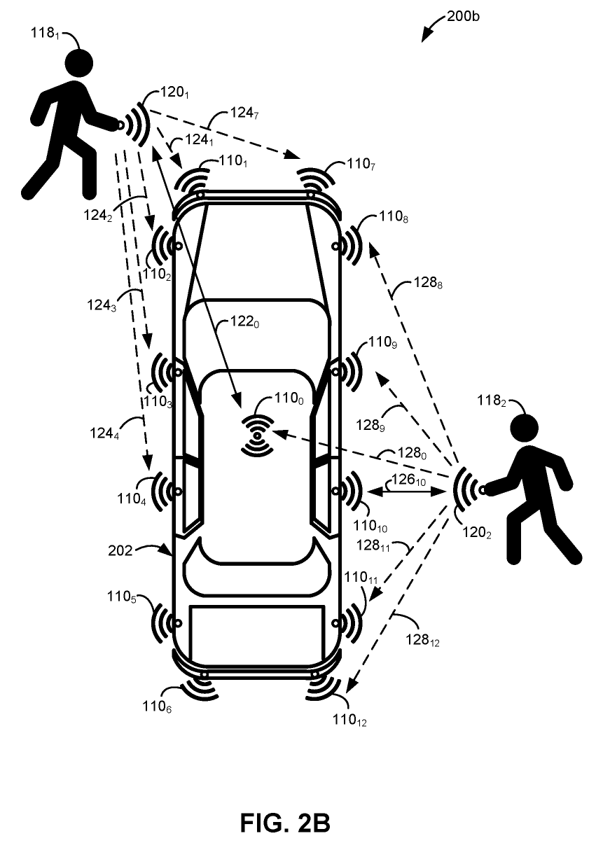

FIG. 1A is a block diagram illustrating an example system 100a including a host controller 102 and a plurality of Bluetooth low energy (BLE) anchors 110₀ to 110_{Y}, where “Y” is any suitable number (e.g., 5, 6, 7, 8, 9, 10, 11, 12, or more) of anchors. The host controller 102 is communicatively coupled to the plurality of BLE anchors 110₀ to 110_{Y} through a communication path 104, such as a bus (e.g., controller area network (CAN) bus, 10Base-T1S bus, universal asynchronous receiver/transmitter (UART) connections, etc.). The plurality of BLE anchors 110₀ to 110_{Y} may include a central BLE anchor 110₀, a first group of BLE anchors 110₁ to 110_{X}, where “X” is any suitable number (e.g., 2, 3, 4, 5, 6 or more) of anchors, and a second group of BLE anchors 110_{X+1} to 110_{Y}. In some examples, the plurality of BLE anchors 110₀ to 110_{Y} may include more than two groups of BLE anchors, such as three, four, or more groups. In some examples, each group of BLE anchors may be arranged on a different side of a vehicle as further described below with reference to FIGS. 2A and 2B.

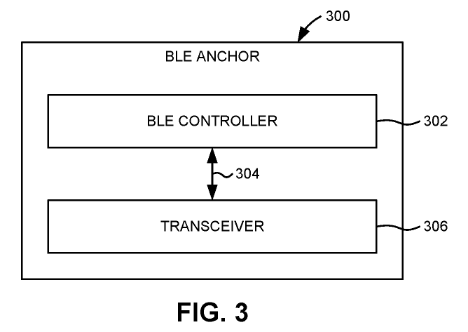

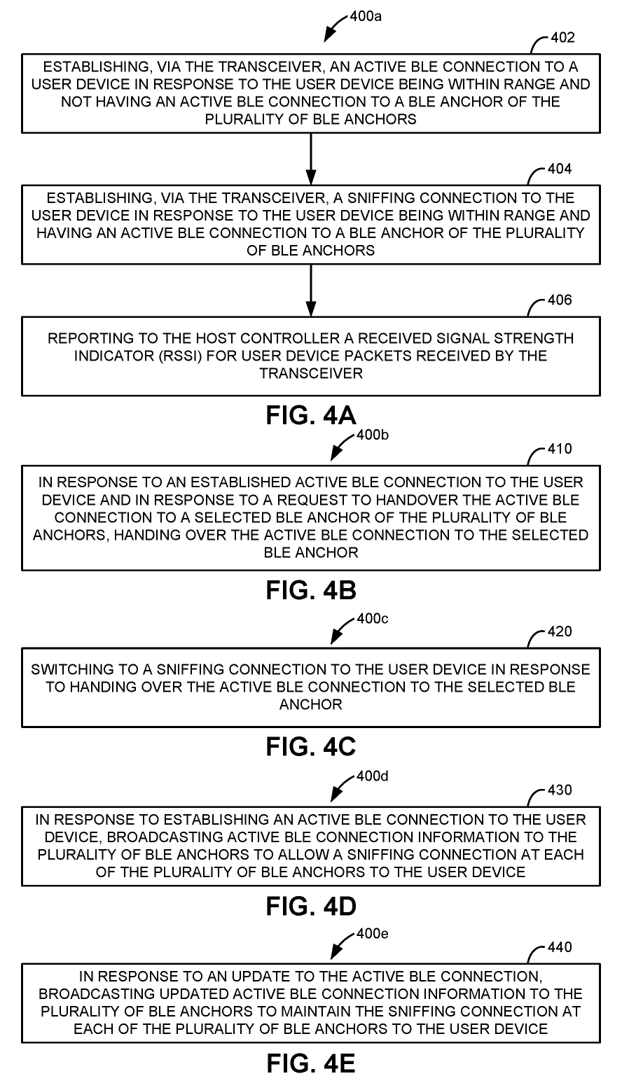

Host controller 102 may include a microcontroller unit (MCU), central processing unit (CPU), or other suitable logic circuitry for managing operations (e.g., sniffing connections, active BLE connections, handing over connections, etc.) between the plurality of BLE anchors 110₀to 110_{Y}. The host controller 102 may also receive received signal strength indicator (RSSI) measurements from the plurality of BLE anchors 110₀ to 110_{Y} to estimate the location of user devices as further described below. In some examples, the central BLE anchor 110₀ may manage communications between the host controller 102 and the plurality of BLE anchors 110₀ to 110_{Y}. In some examples, the central BLE anchor 110₀ may also manage (in place of or in addition to host controller 102) operations (e.g., sniffing connections, active BLE connections, handing over connections, etc.) between the plurality of BLE anchors 110₀to 110_{Y}. Each BLE anchor 110₀ to 110_{Y} includes a BLE controller and a transceiver as further described below with reference to FIGS. 3-4E.

FIG. 1B is a block diagram illustrating an example system 100b including the host controller 102 and the plurality of BLE anchors 110₀to 110_{Y}as previously described and illustrated with reference to FIG. 1A. In addition, system 100b also includes users 118₁and 118₂. Each user 118₁and 118₂ possesses a user device 120₁and 120₂, respectively. In this example, user 118₁ possesses a smart phone 120₁, and user 118₂possesses a key fob 120₂. Each anchor 110₀to 110_{Y}may be connected to up to a plurality of user devices (e.g., 120₁, 120₂, others) using Bluetooth low energy (LE) asynchronous connection-oriented logical (ACL) links, which are referred to herein as active BLE connections. In an active BLE connection, a BLE anchor receives transmissions (e.g., packets) from a user device and responds to the transmissions. A BLE anchor having an active BLE connection to a user device may be referred to herein as an active BLE anchor for the respective user device.

Upon a user device (e.g., 120₁, 120₂) coming within range (e.g., within radio frequency (RF) range) of a BLE anchor 110₀ to 110_{Y}, an active BLE connection is established between a BLE anchor and the user device. If the user device is a smart phone (e.g., 120₁), the smart phone discovers a BLE anchor (that is within RF range) and establishes an active connection with the BLE anchor. If the user device is a key fob (e.g., 120₂), a BLE anchor discovers the key fob and establishes an active BLE connection to the key fob. In some examples, immediately after the BLE anchor establishes the active BLE connection to the key fob, the BLE anchor disconnects from the key fob and starts BLE advertisements to be discovered by the key fob. The key fob then discovers the BLE anchor and establishes an active BLE connection to the BLE anchor. In this example, both user devices 120₁ and 120₂ establish an active BLE connection to central BLE anchor 110₀ as indicated by solid lines 122₀ and 126₀, respectively. In some examples, however, either or both user devices 120₁ and 120₂ may establish an active BLE connection to any one of the BLE anchors 110₀ to 110_{Y}, depending on which BLE anchor first discovers the user device, based on the BLE anchor signal strength to the user device, and/or based on other criteria. In any case, the remaining BLE anchors 110₀ to 110_{Y}, which do not have an active BLE connection to the user device, establish a sniffing connection (if within range) to each user device. In this example, each BLE anchor 110₁ to 110_{Y} establishes a sniffing connection to user device 120₁ and 120₂ as indicated by dashed lines 124₁ to 124_{Y} and 128₁ to 128_{Y}, respectively. In a sniffing connection, a BLE anchor receives (e.g., listens, eavesdrops) on transmissions (e.g., packets) from a user device but does not respond to the transmissions. A BLE anchor having a sniffing connection to a user device may be referred to herein as a sniffing BLE anchor for the respective user device.

Each of the BLE anchors 110₀to 110_{Y}, during both active and sniffing connections, measures the received signal strength indicator (RSSI) of the packets received from the user devices (e.g., 120₁, 120₂). The RSSI measurements from the BLE anchors 110₀to 110_{Y}may be delivered to the host controller 102 through the communication path 104. The host controller 102 may then calculate the range and/or location (e.g., via trilateration) of each corresponding user device 120₁and 120₂ based on the corresponding received RSSI measurements. The range and/or location of each user device 120₁and 120₂may be used to perform specific actions, such as starting UWB ranging on selected UWB anchors, unlocking a door, flashing welcome lights, etc.

While system 100b includes two users 118₁and 118₂each possessing a single user device 120₁and 120₂, respectively, in some examples, system 100b may include a single user or more than two users, and each user may possess more than one user device (e.g., smart phone, smart watch, key fob, etc.).

FIG. 2A is a schematic diagram 200a illustrating an example vehicle 202 including BLE anchors 110₀to 110₁₂(e.g., X = 6, Y = 12 in FIGS. 1A and 1B). BLE anchors 110₀to 110₁₂are communicatively coupled to a host controller 102 (not shown in FIG. 2A) as previously described and illustrated with reference to FIGS. 1A and 1B. Central BLE anchor 110₀may be arranged within the vehicle 202 at a central location. BLE anchors 110₁to 110₆ may be arranged on a first side (e.g., driver side) of the vehicle 202, and BLE anchors 110₇to 110₁₂may be arranged on a second side (e.g., passenger side) of the vehicle 202 opposite to the first side. While vehicle 202 includes thirteen BLE anchors in the example illustrated in FIG. 2A, in some examples, vehicle 202 may include less than thirteen BLE anchors (e.g., 3, 4, 5, 6, 7, 8, 9, 10, 11, 12) or more than thirteen BLE anchors (e.g., 14, 15, 16, or more).

Host controller 102 of vehicle 202 detects the proximity of a user device 120₁and 120₂to the vehicle over BLE connections using the multiple BLE anchors 110₀to 110₁₂through sniffing and handover of active BLE connections. For example, as user 118₁possessing user device 120₁approaches the vehicle 202 from the rear side of the vehicle, BLE anchor 110₆may establish an active BLE connection to user device 120₁as indicated by solid line 122₆. As the user moves to the driver side of the vehicle 202 as indicated by dashed line 204, the active BLE connection to user device 120₁may be handed off from BLE anchor 110₆to BLE anchor 110₃as indicated by solid line 122₃. In some examples, the active BLE connection may first be handed off to BLE anchor 110₅and/or to BLE anchor 110₄prior to being handed off to BLE anchor 110₃. The handover of the active BLE connections between the BLE anchors ensures an uninterrupted connection between the host controller 102 of the vehicle 202 and the user device 120₁.

At the same time, a user 118₂possessing user device 120₂may approach the vehicle 202 from the passenger side of the vehicle. In response, BLE anchor 110₁₀may establish an active BLE connection to user device 120₂as indicated by solid line 126₁₀. Additional users possessing a user device (not shown) may also approach the vehicle 202 and establish an active connection to a BLE anchor 110₀to 110₁₂, which may be handed off to another BLE anchor as the user moves around the vehicle 202.

FIG. 2B is a schematic diagram 200b illustrating the example vehicle 202 including BLE anchors 110₀to 110₁₂ as previously described and illustrated with reference to FIG. 2A. The BLE system of vehicle 202 may be used to enable vehicle access by providing a data pathway to perform authentication of a user device (e.g., 120₁, 120₂) for vehicle access and to estimate the range and/or location of the user device. To achieve faster authentication, it may be beneficial to establish a connection between the vehicle BLE system and a user device and start estimating the range and/or location of the user device as soon as the user device comes into range of any BLE anchor 110₀to 110₁₂.

Accordingly, when a user device (e.g., 120₁, 120₂) comes within range of any BLE anchor 110₀to 110₁₂, an active BLE connection is established between one BLE anchor and the user device and a sniffing connection is established between the remaining BLE anchors (that are within range) and the user device. Bluetooth LE advertisements and/or scanning by BLE anchors 110₀to 110₁₂enable a user device to be discovered and establish a connection to the host controller (e.g., 102 of FIGS. 1A and 1B) through the BLE anchors. All BLE anchors 110₀to 110₁₂within the system may use the same Bluetooth device address, such that the user devices see a single Bluetooth device (e.g., all the BLE anchors 110₀to 110₁₂appear as a single Bluetooth device from the perspective of the user devices).

The active BLE connection and the sniffing connections to a user device (e.g., 120₁, 120₂) may be maintained as long as the user device remains within range of the vehicle 202 (e.g., within range of at least one BLE anchor 110₀to 110₁₂). At every BLE connection interval (e.g., the time between two data transfer events between a BLE anchor and a user device), each BLE anchor (active and sniffing) reports the RSSI of the transmission (e.g., packets) received from the user device to the host controller (e.g., 102 of FIGS. 1A and 1B). In some examples, a sniffing BLE anchor may potentially tune to the packets sent by another BLE anchor, rather than to the user device. To prevent this, a cyclic redundancy check (CRC) and/or a message integrity check (MIC) of the received packets may be used to validate that the received packets are from the user device. With an active BLE connection between a user device and the active BLE anchor, the user device and the active BLE anchor exchange packets, such that after the user device sends a packet, the active BLE anchor immediately replies with a packet. Sniffing BLE anchors receive packets sent by the user device and determine a RSSI value from the received packets. In some cases, a sniffing BLE anchor may receive a packet sent by the active BLE anchor by mistake and assume the packet was sent by the user device. In this case the RSSI value will be incorrect. To work around this potential issue, the active BLE anchor and the sniffing BLE anchors may send CRC and/or MIC of the received packet along with the RSSI value to the host controller. The host controller then compares the CRC and/or MIC of the packet sent by the active BLE anchor with the CRC and/or MIC sent by each sniffing BLE anchor. If the CRC and/or MIC of the active BLE anchor does not match the CRC and/or MIC of a particular sniffing BLE anchor, the RSSI value sent by that particular sniffing BLE anchor is ignored and the host controller instructs the particular sniffing BLE anchor to resync with the user device. Accordingly, CRC and/or MIC of the packets may be used to validate that the RSSI of the correct packets (e.g., for packets received from the user device and not from active BLE anchors) is reported. The RSSI reports from each BLE anchor are used by the host controller (e.g., 102 of FIGS. 1A and 1B) to estimate the user device (and thus the user) location and to make active BLE connection handover decisions. As soon as an active BLE connection to a first BLE anchor of BLE anchors 110₀to 110₁₂is established, the first BLE anchor broadcasts the active BLE connection information to the remaining BLE anchors of BLE anchors 110₀to 110₁₂to establish a sniffing connection to the user device.

Active BLE connections and sniffing connections are seamlessly exchanged (e.g., without the active connection to the user device being interrupted, such that reconnection and reauthentication of the user device is not necessary) between the BLE anchors 110₀to 110₁₂. While the central BLE anchor 110₀has a sniffing connection to a user device, the central BLE anchor may decide to take over (handover) the active BLE connection when the RSSI values indicate that the central BLE anchor can maintain a solid active BLE connection. The handover may also be performed between BLE anchors 110₁to 110₁₂when the user moves outside of the range of the active BLE anchor (e.g., when the user moves around the vehicle 202).

In the example illustrated in FIG. 2B, user 118₁possessing user device 120₁includes an active BLE connection to central BLE anchor 110₀as indicated by solid line 122₀and sniffing connections to at least BLE anchors 110₁to 110₄and 110₇. The remaining anchors 110₅, 110₆, and 110₈to 110₁₂may also establish sniffing connections if they are within RF range of the user device 120₁. Prior to establishing the active BLE connection to central BLE anchor 110₀, another BLE anchor 110₁to 110₁₂may have established an active BLE connection to the user device 120₁and then transferred the active BLE connection to the central BLE anchor 110₀as the user 118₁moved around the vehicle 202. When the user device 120₁comes into the RF range of the central BLE anchor 110₀, the central BLE anchor may perform a sniff handover so that the central BLE anchor has the active BLE connection to the user device 120₁while all other anchors (within range) have a sniffing connection to the user device 120₁. Based on the RSSI measurements from each BLE anchor including either an active or sniffing connection to the user device 120₁, the host controller (e.g., 102 of FIGS. 1A and 1B) may calculate the location of user 118₁as the user 118₁approaches and/or moves around the vehicle 202.

User 118₂possessing user device 120₂may first establish an active connection to BLE anchor 110₁₀as indicated by solid line 126₁₀and sniffing connections to at least BLE anchors 110₀, 110₈, 110₉, 110₁₁, and 110₁₂. The remaining anchors 110₁ to 110₇may also establish sniffing connections if they are within RF range of the user device 120₂. As the user 118₂gets closer to the vehicle 202, the active BLE connection may be transferred to central BLE anchor 110₀and BLE anchor 110₁₀may establish a sniffing connection to user device 120₂. Based on the RSSI measurements from each BLE anchor including either an active or sniffing connection to the user device 120₂, the host controller (e.g., 102 of FIGS. 1A and 1B) may calculate the location of user 118₂as the user 118₂approaches and/or moves around the vehicle 202. Based on the locations of users 118₁and 118₂, the host controller may unlock the door closest to each user 118₁and 118₂and/or perform another action, such as turning on specific UWB anchors for UWB ranging.

FIG. 3 is a block diagram illustrating an example BLE anchor 300. BLE anchor 300 may provide each BLE anchor 110₀to 110_{Y} of FIGS. 1A and 1B (e.g.,. 110₀to 110₁₂of FIGS. 2A and 2B). BLE anchor 300 includes a BLE controller 302 and a transceiver 306. BLE controller 302 is communicatively coupled to transceiver 306 through a communication path 304. When implemented within a BLE system (e.g., 100a of FIG. 1A, 100b of FIG. 1B, 200a of FIG. 2A, 200b of FIG. 2B), BLE controller 302 may be communicatively coupled to a plurality of BLE anchors (e.g., 110₀to 110_{Y}) and a host controller (e.g., 102) via a bus (e.g., 104). BLE controller 302 controls the operations of BLE anchor 300 including transmitting and receiving packets via transceiver 306. Transceiver 306 includes an RF radio and antenna for transmitting and receiving packets using a BLE communication protocol.

FIGS. 4A-4E are flow diagrams illustrating example methods 400a-400e for operating a BLE anchor. Methods 400a-400e may be implemented by BLE controller 302 of BLE anchor 300 of FIG. 3. In some examples, the methods 400a-400e may be implemented in hardware (e.g., logic circuits) of BLE controller 302 and/or by BLE controller 302 executing machine readable instructions (e.g., software or firmware) stored in a non-transitory machine readable storage medium (e.g., memory) of BLE anchor 300.

As illustrated in FIG. 4A at 402, method 400a includes establishing, via the transceiver (e.g., 306), an active BLE connection (e.g., 122₀or 126₀of FIG. 1B; 122₃, 122₆, or 126₁₀of FIG. 2A; 122₀or 126₁₀of FIG. 2B) to a user device (e.g., 120₁or 120₂of FIGS. 1B-2B) in response to the user device being within range and not having an active BLE connection to a BLE anchor of the plurality of BLE anchors (e.g., 110₀to 110_{Y} of FIGS. 1A and 1B, 110₀ to 110₁₂of FIGS. 2A and 2B). At 404, method 400a includes establishing, via the transceiver, a sniffing connection (e.g., 124₁to 124_{Y} or 128₁to 128_{Y} of FIG. 1B; 124₁to 124₄and 124₇or 128₀, 128₈, 128₉, 128₁₁, and 128₁₂of FIG. 2B) to the user device in response to the user device being within range and having an active BLE connection to a BLE anchor of the plurality of BLE anchors. At 406, method 400a includes reporting to the host controller (e.g., 102 of FIGS. 1A and 1B) a received signal strength indicator (RSSI) for user device packets received by the transceiver.

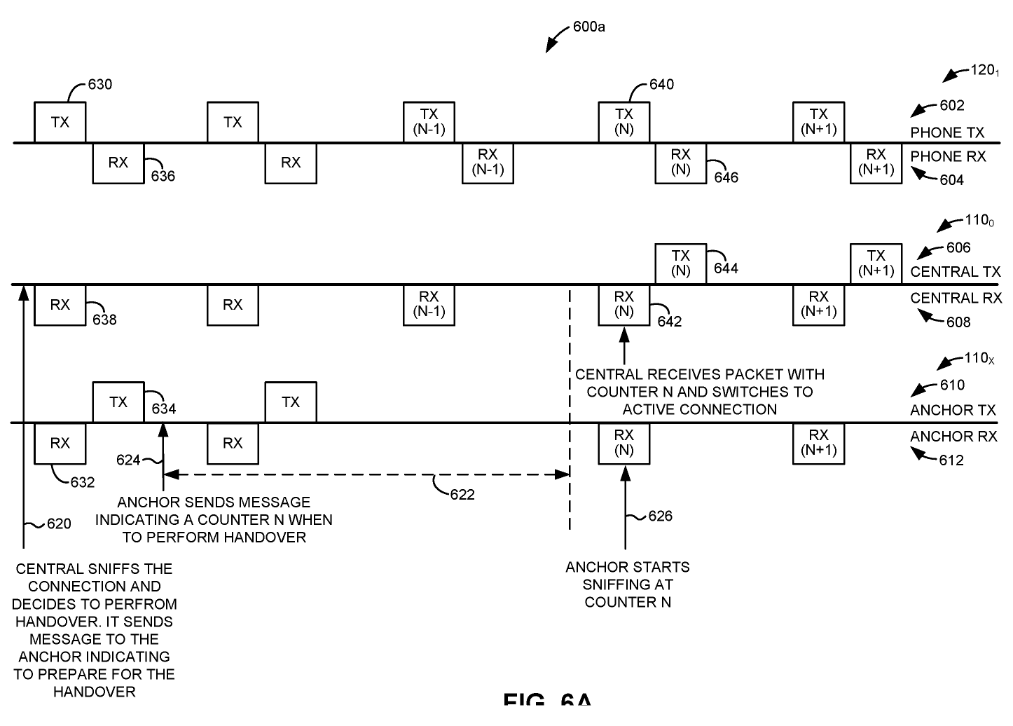

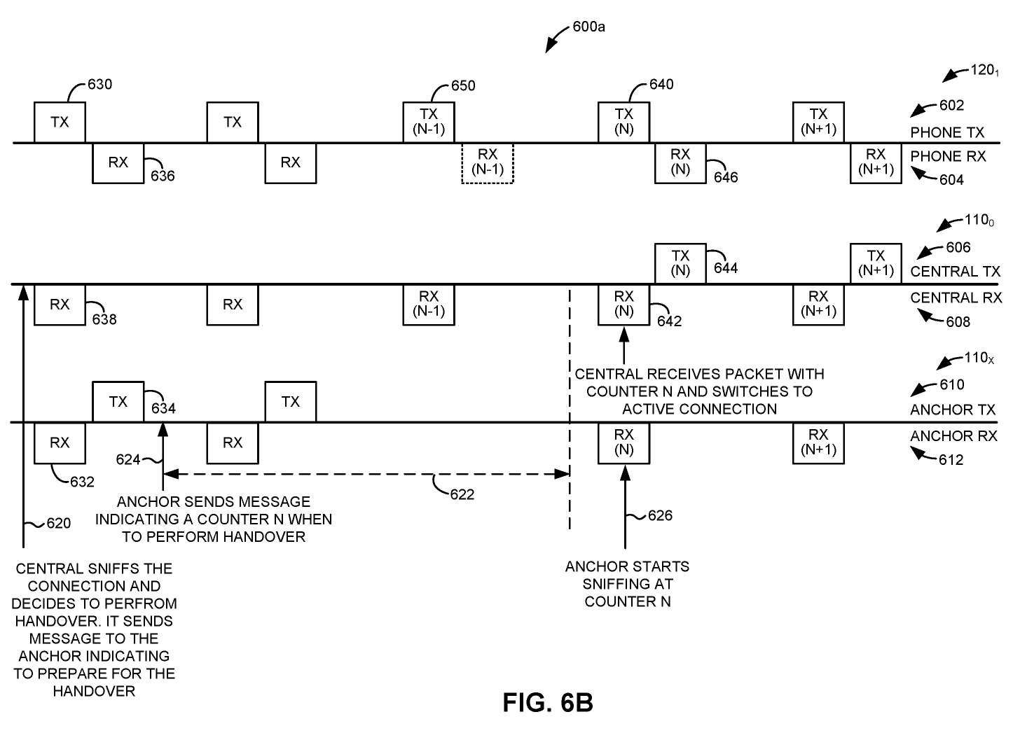

In some examples, method 400a of FIG. 4A may further include method 400b of FIG. 4B. As illustrated in FIG. 4B at 410, method 400b may include in response to an established active BLE connection to the user device and in response to a request (e.g., from host 102 of FIGS. 1A and 1B) to handover the active BLE connection to a selected BLE anchor of the plurality of BLE anchors, handing over the active BLE connection to the selected BLE anchor. In some examples, the handover request includes an indication of when the handover is to be performed. In this case, the BLE controller is configured to handover the active BLE connection to the selected BLE anchor based on the indication as further described below with reference to FIGS. 6A and 6B.

In some examples, method 400b of FIG. 4B may further include method 400c of FIG. 4C. As illustrated in FIG. 4C at 420, method 400c may include switching to a sniffing connection to the user device in response to handing over the active BLE connection to the selected BLE anchor.

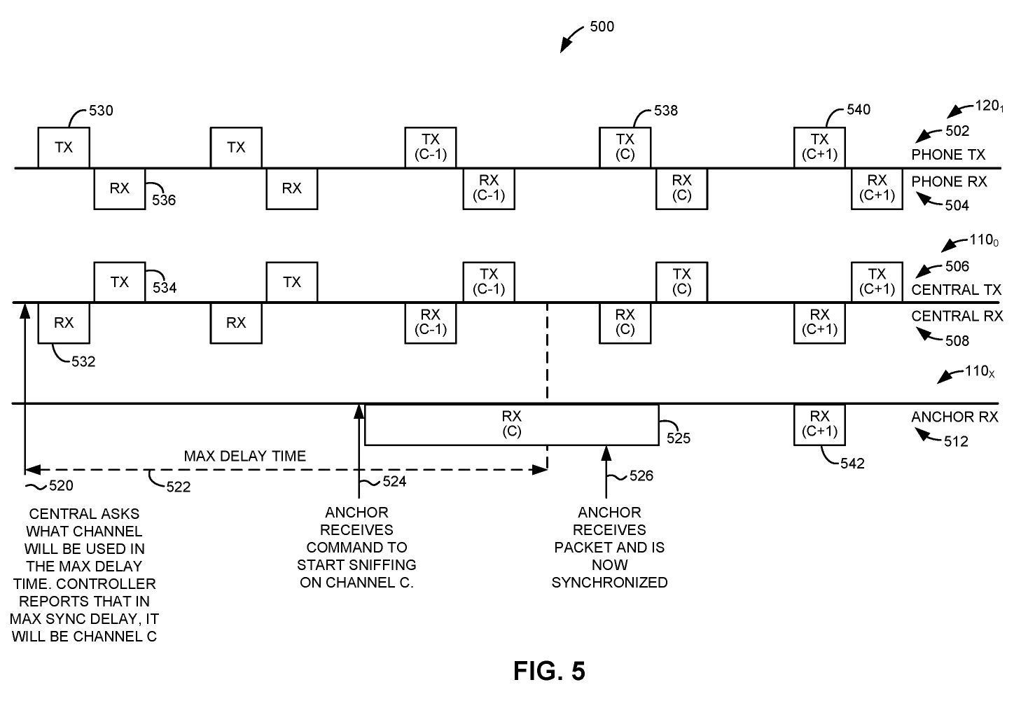

In some examples, method 400a of FIG. 4A may further include method 400d of FIG. 4D. As illustrated in FIG. 4D at 430, method 400d may include in response to establishing an active BLE connection to the user device, broadcasting active BLE connection information (which is further described below with reference to FIG. 5) to the plurality of BLE anchors to allow a sniffing connection at each of the plurality of BLE anchors to the user device (e.g., to establish a sniffing connection at each of the plurality of BLE anchors within RF range of the user device).

In some examples, method 400d of FIG. 4D may further include method 400e of FIG. 4E. As illustrated in FIG. 4E at 440, method 400e includes in response to an update to the active BLE connection, broadcasting updated active BLE connection information to the plurality of BLE anchors to maintain the sniffing connection at each of the plurality of BLE anchors to the user device.

FIG. 5 is a timing diagram 500 illustrating an example method for establishing a sniffing connection at a BLE anchor (e.g.,110_{X}). To start a sniffing connection, the BLE anchor needs to know the parameters of the active BLE connection, which are exchanged between the user device and the active BLE anchor. The active BLE connection parameters (e.g., information) may include an access address, connection interval, supervision timeout, channel map, receive physical layer (RX PHY), transmit physical layer (TX PHY), encryption enabled, sleep clock accuracy, initial channel, initial connection counter, and/or other parameters. The parameters may be exchanged over a wired communication path 104 (FIGS. 1A and 1B), such as a CAN bus. To determine the channel the sniffing BLE anchor will be listening to, the active BLE anchor should know the maximum amount of time it will take for the parameters to be delivered to the sniffing BLE anchors over the communication path. As such, the active BLE anchor calculates the channel that will be used at some point in the future, which corresponds to the maximum amount of time it will take for the parameters to be delivered from the active BLE anchor to the sniffing BLE anchors.

For example, as shown in FIG. 5, a user device 120₁(e.g., phone) transmits packets (TX) as indicated at 502 and receives packets (RX) as indicated at 504. The central BLE anchor 110₀, which is the active BLE anchor in this example, transmits packets (TX) as indicated at 506 and receives packets (RX) as indicated at 508. The sniffing BLE anchor 110_{X} receives packets (RX) as indicated at 512. In this example, the central BLE anchor 110₀and the phone 120₁have an active BLE connection, such that each transmission (e.g., 530) of the phone is received (e.g., 532) by the central BLE anchor and in response, the central BLE anchor responds to the phone with a transmission (e.g., 534), which is received by the phone (e.g., 536). The central BLE anchor 110₀knows that it may take up to a max delay time as indicated at 522 (e.g., 100 milliseconds) to deliver an instruction packet over the communication path (e.g., 104 of FIGS. 1A and 1B) to the BLE anchor 110_{X}. Accordingly, the central BLE anchor may retrieve the channel (C in this example) that will be used by the phone 120₁at the max delay time and reports this channel (among other parameters) to the BLE anchor 110_{X} as indicated at 520. The BLE anchor 110_{X} receives the report within the max delay time as indicated at 524 to start sniffing on channel C. In response to receiving the report at 524, the BLE anchor 110_{X} starts sniffing on channel C as indicated at 525. Once the TX packet on channel C (e.g., 538) is received as indicated at 526, the BLE anchor 110_{X} is synchronized and the sniffing connection is established between the sniffing BLE anchor 110_{X} and the phone 120₁. With the sniffing connection active, each further packet (e.g., 540) transmitted by the phone is received (e.g., 542) by the sniffing BLE anchor 110_{X}.

There are situations during an active BLE connection where the phone 120₁may update the connection. For example, the phone 120₁may change the connection periodic offset or BLE connection interval. The phone 120₁may also switch to a different PHY or a different channel map to avoid interference. To allow uninterrupted reporting of the RSSI measurements, the active BLE anchor (e.g., central BLE anchor 110₀in FIG. 5) may notify all other BLE anchors (e.g., sniffing BLE anchors including BLE anchor 110_{X} in FIG. 5) about upcoming updates to maintain synchronization between the sniffing BLE anchors and the phone 120₁.

FIG. 6A is a timing diagram 600a illustrating an example method for handing over an active BLE connection from one BLE anchor (e.g., 110_{X}) to another BLE anchor (e.g., 110₀). In this example, a user device 120₁(e.g., phone) transmits packets (TX) as indicated at 602 and receives packets (RX) as indicated at 604. The central BLE anchor 110₀transmits packets (TX) as indicated at 606 and receives packets (RX) as indicated at 608. A BLE anchor 110_{X} transmits packets (TX) as indicated at 610 and receives packets (RX) as indicated at 612. In this example, the BLE anchor 110_{X} and the phone 120₁have an active BLE connection. While in the active BLE connection, each transmission (e.g., 630) of the phone 120₁is received (e.g., 632) by the BLE anchor 110_{X} and in response, the BLE anchor 110_{X} responds to the phone 120₁ with a transmission (e.g., 634), which is received (e.g., 636) by the phone 120₁. While in a sniffing connection, each transmission (e.g., 630) of the phone 120₁is received (e.g., 638) by the central BLE anchor 110₀, and the central BLE anchor 110₀does not reply. To perform a handover, the roles of the active anchor and the sniffing anchor change. To begin a handover, the sniffing BLE anchor that will become the active BLE anchor sends a request to the currently active BLE anchor indicating when the handover should be implemented.

For example, as shown in FIG. 6A, the central BLE anchor 110₀sniffs the connection between the phone 120₁and the BLE anchor 110_{X} and decides to perform a handover as indicated at 620. The central BLE anchor 110₀sends a message to the BLE anchor110_{X} (e.g., over the communication path 104 of FIGS. 1A and 1B) to prepare for the handover. Upon receiving the message to prepare for the handover, the active BLE anchor 110_{X} sends a message to the host controller (e.g., 102 of FIGS. 1A and 1B) indicating a counter N when the BLE anchor 110_{X} is to perform the handover. Within a max delay time as indicated at 622, the central BLE anchor 110₀ receives the command to switch to an active connection at counter N as indicated at 624. At 626, the BLE anchor 110_{X} starts sniffing at counter N corresponding to transmission 640 of phone 110₁and stops transmitting (e.g., stops replying to the phone 120₁). At the same time, the central BLE anchor 110₀receives the packet 642 at counter N and begins transmitting (e.g., replying to the phone), such that in response to receiving packet 642, the central BLE anchor 110₀responds by transmitting packet 644, which is received by the phone 120₁at 646. Accordingly, the active BLE connection is seamlessly handed over from the BLE anchor 110_{X} to the central BLE anchor 110₀, such that the active BLE connection to the phone 120₁is uninterrupted and the handover does not force the phone to reconnect and reauthenticate to the central BLE anchor 110₀.

FIG. 6B is a timing diagram 600b illustrating an example method for handing over an active BLE connection from one BLE anchor (e.g., 110_{X}) to another BLE anchor (e.g., 110₀). Timing diagram 600b is similar to timing diagram 600a previously described and illustrated with reference to FIG. 6A, except that in timing diagram 600 bif the active BLE anchor acknowledges a transmission from the phone 120₁after receiving the message to prepare for a handover as indicated at 624, the phone 120₁may send another packet within the same connection interval increasing the packet counter. This may disallow the BLE anchor that wants to become active from establishing encryption with the phone 120₁. To avoid this, the active BLE anchor should not reply to transmissions from the phone 120₁that would cause the phone to retransmit within the same connection interval, thereby keeping the packet counter known to both the active BLE anchor and sniffing BLE anchors.

For example, after the BLE anchor 110_{X} receives the command at 624 to prepare for a handover, the phone 120₁transmits a packet 650 with counter N-1. If responding to the received packet 652 would result in the phone 120₁sending another packet within the same connection interval increasing the packet counter, the BLE anchor 110_{X}should not respond. By not responding, the phone 120₁is kept from retransmitting within the same connection interval and the packet counter remains known to both the active BLE anchor 110_{X}and the sniffing central BLE anchor 110₀. Accordingly, the handover can be implemented at counter N at the transmission of packet 640 as previously described with reference to FIG. 6A.

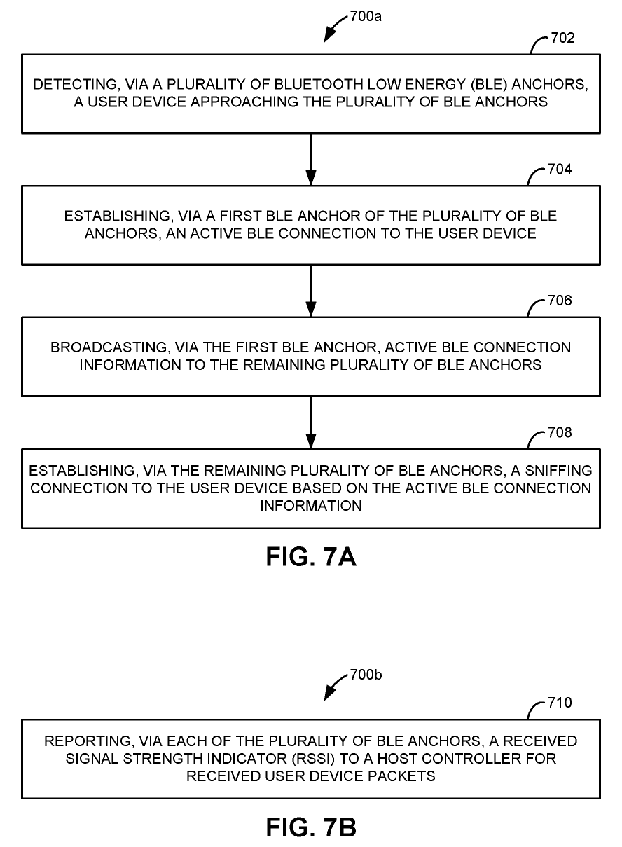

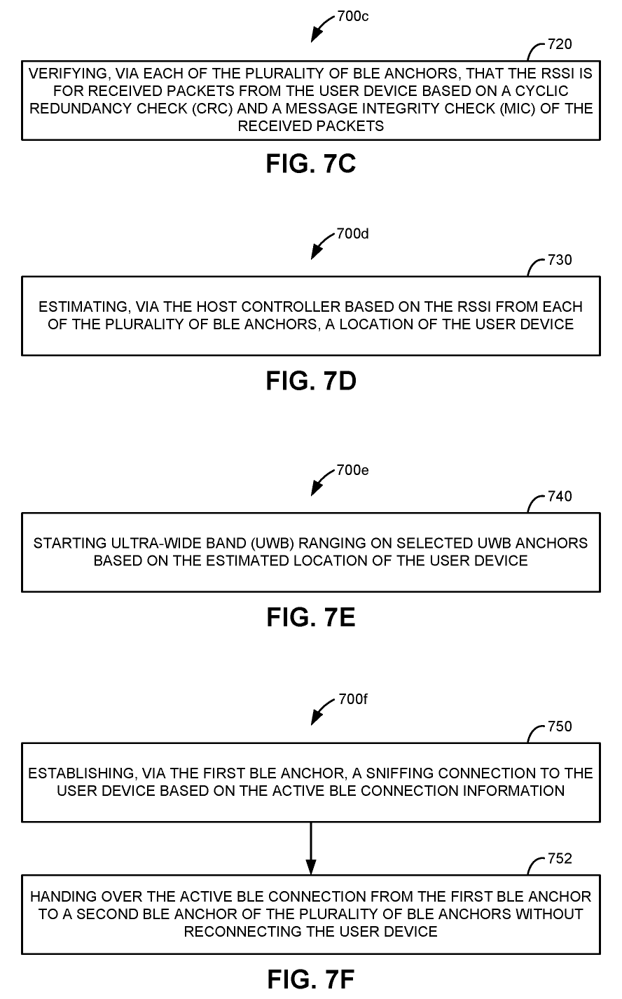

FIGS. 7A-7F are flow diagrams illustrating example methods 700a-700f for operating systems including BLE anchors. Methods 700a-700f may be implemented by a host controller 102 and BLE anchors 110₀to 110_{Y} (FIGS. 1A-2B). In some examples, the methods 700a-700f may be implemented in hardware (e.g., logic circuits) of host controller 102 and/or BLE anchors 110₀to 110_{Y} and/or by host controller 102 or BLE controllers 302 of BLE anchors 110₀to 110_{Y} executing machine readable instructions (e.g., software or firmware) stored in a non-transitory machine readable storage medium (e.g., memory).

As illustrated in FIG. 7A at 702, method 700a includes detecting, via a plurality of Bluetooth low energy (BLE) anchors (e.g., 110₀to 110_{Y}), a user device (e.g., 120₁, 120₂) approaching the plurality of BLE anchors. At 704, method 700a includes establishing, via a first BLE anchor (e.g., 110₀, 110₁₀of FIG. 2B) of the plurality of BLE anchors, an active BLE connection (e.g., 122₀, 126₁₀of FIG. 2B) to the user device. At 706, method 700a includes broadcasting (e.g., over communication path 104 of FIGS. 1A and 1B), via the first BLE anchor, active BLE connection information (e.g., access address, connection interval, supervision timeout, channel map, RX PHY, TX PHY, encryption enabled, sleep clock accuracy, initial channel, initial connection counter, etc.) to the remaining plurality of BLE anchors. At 708, method 700a includes establishing, via the remaining plurality of BLE anchors (within range), a sniffing connection (e.g., 124₁to 124₄and 124₇; 128₀, 128₈, 128₉, 128₁₁, and 128₁₂of FIG. 2B) to the user device based on the active BLE connection information.

In some examples, method 700a of FIG. 7A may further include method 700b of FIG. 7B. As illustrated in FIG. 7B at 710, method 700b may include reporting (e.g., over communication path 104 of FIGS. 1A and 1B), via each of the plurality of BLE anchors, a received signal strength indicator (RSSI) to a host controller (e.g., 102 of FIGS. 1A and 1B) for received user device packets.

In some examples, method 700b of FIG. 7B may further include method 700c of FIG. 7C. As illustrated in FIG. 7C at 720, method 700c may include verifying, via each of the plurality of BLE anchors, that the RSSI is for received packets from the user device based on a cyclic redundancy check (CRC) and a message integrity check (MIC) of the received packets.

In some examples, method 700b of FIG. 7B may further include method 700d of FIG. 7D. As illustrated in FIG. 7D at 730, method 700d may include estimating, via the host controller based on the RSSI from each of the plurality of BLE anchors, a location of the user device.

In some examples, method 700d of FIG. 7D may further include method 700e of FIG. 7E. As illustrated in FIG. 7E at 740, method 700e may include starting ultra-wide band (UWB) ranging on selected UWB anchors based on the estimated location of the user device.

In some examples, method 700a of FIG. 7A may further include method 700f of FIG. 7F. As illustrated in FIG. 7F at 750, method 700f may include establishing, via the first BLE anchor, a sniffing connection to the user device based on the active BLE connection information. At 752, method 700f may include handing over the active BLE connection from the first BLE anchor to a second BLE anchor of the plurality of BLE anchors without reconnecting the user device (e.g., as described with reference to FIGS. 6A and 6B).

It is to be understood that the features of the various exemplary embodiments described herein may be combined with each other, unless specifically noted otherwise.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A Bluetooth low energy (BLE) anchor comprising:
a BLE controller configured to be communicatively coupled to a plurality of BLE anchors and a host controller; and
a transceiver communicatively coupled to the BLE controller,
wherein the BLE controller is configured to:
establish, via the transceiver, an active BLE connection to a user device in response to the user device being within range and not having an active BLE connection to a BLE anchor of the plurality of BLE anchors;
establish, via the transceiver, a sniffing connection to the user device in response to the user device being within range and having an active BLE connection to a BLE anchor of the plurality of BLE anchors; and
report to the host controller a received signal strength indicator (RSSI) for user device packets received by the transceiver.

2. The BLE anchor of claim 1, wherein the BLE controller is configured to, in response to an established active BLE connection to the user device and in response to a request to handover the active BLE connection to a selected BLE anchor of the plurality of BLE anchors, handover the active BLE connection to the selected BLE anchor.

3. The BLE anchor of claim 2, wherein the handover request includes an indication of when the handover is to be performed, and
wherein the BLE controller is configured to handover the active BLE connection to the selected BLE anchor based on the indication.

4. The BLE anchor of claim 2, wherein the controller is configured to switch to a sniffing connection to the user device in response to handing over the active BLE connection to the selected BLE anchor.

5. The BLE anchor of claim 1, wherein the BLE controller is configured to, in response to establishing an active BLE connection to the user device, broadcast active BLE connection information to the plurality of BLE anchors to allow a sniffing connection at each of the plurality of BLE anchors to the user device.

6. The BLE anchor of claim 5, wherein the BLE controller is configured to, in response to an update to the active BLE connection, broadcast updated active BLE connection information to the plurality of BLE anchors to maintain the sniffing connection at each of the plurality of BLE anchors to the user device.

7. A system comprising:
a host controller; and
a plurality of Bluetooth low energy (BLE) anchors communicatively coupled to the host controller,
wherein in response to detecting a user device, a first BLE anchor of the plurality of BLE anchors establishes an active BLE connection with the user device and broadcasts active BLE connection data to the remaining plurality of BLE anchors,
wherein in response to receiving the active BLE connection data, each of the remaining plurality of BLE anchors establish a sniffing connection to the user device,
wherein each of the plurality of BLE anchors reports a received signal strength indicator (RSSI) for received user device packets to the host controller, and
wherein the host controller estimates a location of the user device based on the RSSI received from each of the plurality of BLE anchors.

8. The system of claim 7, wherein the host controller starts ultra-wide band (UWB) ranging on selected UWB anchors based on the RSSI received from each of the plurality of BLE anchors.

9. The system of claim 7, wherein a second BLE anchor of the plurality of BLE anchors takes over the active BLE connection from the first BLE anchor in response to determining the first BLE anchor cannot maintain the active BLE connection.

10. The system of claim 9, wherein a handover of the active BLE connection from the first BLE anchor to the second BLE anchor is coordinated between the first BLE anchor and the second BLE anchor to occur at a specific point in time.

11. The system of claim 7, wherein the plurality of BLE anchors includes a central BLE anchor,
wherein the central BLE anchor takes over the active BLE connection from the first BLE anchor in response to determining the central BLE anchor can maintain the active BLE connection, and
wherein in response to handing over the active BLE connection to the central BLE anchor, the first BLE anchor establishes a sniffing connection to the user device.

12. The system of claim 7, wherein in response to an update of the active BLE connection, the first BLE anchor broadcasts updated active BLE connection data to the remaining plurality of BLE anchors, and
wherein each of the remaining plurality of BLE anchors maintains the respective sniffing connection based on the updated active BLE connection data.

13. The system of claim 7, wherein each of the plurality of BLE anchors use the same Bluetooth address.

14. The system of claim 7, wherein the system comprise a vehicle BLE system.

15. A method comprising:
detecting, via a plurality of Bluetooth low energy (BLE) anchors, a user device approaching the plurality of BLE anchors;
establishing, via a first BLE anchor of the plurality of BLE anchors, an active BLE connection to the user device;
broadcasting, via the first BLE anchor, active BLE connection information to the remaining plurality of BLE anchors; and
establishing, via the remaining plurality of BLE anchors, a sniffing connection to the user device based on the active BLE connection information.

16. The method of claim 15, further comprising:
reporting, via each of the plurality of BLE anchors, a received signal strength indicator (RSSI) to a host controller for received user device packets.

17. The method of claim 16, further comprising:
verifying, via each of the plurality of BLE anchors, that the RSSI is for received packets from the user device based on a cyclic redundancy check (CRC) and a message integrity check (MIC) of the received packets.

18. The method of claim 16, further comprising:
estimating, via the host controller based on the RSSI from each of the plurality of BLE anchors, a location of the user device.

19. The method of claim 18, further comprising:
starting ultra-wide band (UWB) ranging on selected UWB anchors based on the estimated location of the user device.

20. The method of claim 15, further comprising:
establishing, via the first BLE anchor, a sniffing connection to the user device based on the active BLE connection information; and
handing over the active BLE connection from the first BLE anchor to a second BLE anchor of the plurality of BLE anchors without reconnecting the user device.
